(19) United States
(12) Patent Application Publication
(10) Pub. No.: US 2021/0162805 A1
(43) Pub. Date: Jun. 3, 2021

(54) DEVICE FOR SCATTERING GRIT IN FRONT OF THE WHEELS OF A VEHICLE

(71) Applicant: NOWE GmbH, Elze (DE)

(72) Inventors: Alexander REICH, Meerbusch (DE); Werner BARTLING, Elze (DE); Ralf WEIß, Gronau OT Banteln (DE)

(73) Assignee: NOWE GmbH, Elze (DE)

(21) Appl. No.: 17/262,380

(22) PCT Filed: Aug. 19, 2019
(86) PCT No.: PCT/EP2019/072079

§ 371 Date: Jan. 22, 2021

(30) Foreign Application Priority Data
Aug. 20, 2018 (AT) A 50706/2018

(51) Int. Cl. B60B 39/02; B60B 39/04

(52) U.S. Cl. CPC B60B 39/021; B60B 39/04

(57) ABSTRACT

A device for scattering grit in front of the wheels of a vehicle comprises a housing having a feed inlet for the grit, an outlet for the grit and a substantially cylindrical recess for receiving a brush roll which is rotatably mounted and driven about a substantially horizontal axis of rotation for the metered delivery of the grit from the feed inlet to the outlet. At least one wedge is arranged in the region of the feed inlet for the grit, in front of the brush roll and tangentially and displaceably with respect to the brush roll so that the size of the feed inlet can be adjusted.

The invention relates to a device for scattering grit in front of the wheels of a vehicle, comprising a housing having a feed inlet for the grit, an outlet for the grit and a substantially cylindrical recess for receiving a brush roll which is rotatably mounted and driven about a substantially horizontal axis of rotation for the metered delivery of the grit from the feed inlet to the outlet.

If there is insufficient static friction between the wheels of a vehicle and the ground, there is the risk that when starting up the vehicle, the drive wheels will spin as a result of the inadequate traction and during a braking process the wheels will slide on the ground and result in the braking distance being too long. For this reason sand or grit scattering devices are used in which sand or grit is scattered in front of the vehicle wheels in order to increase the static friction and facilitate the starting up of the vehicle or shorten the braking distance.

For example, U.S. Pat. No. 1,793,689 A describes a sand scattering device with an electrical fan for dispensing the sand via a corresponding nozzle. This device is unsuitable for dispensing coarse-grained grit.

Improvements can be achieved with constructions such as that, for example, according to AT 504 905 B1 wherein the sand or grit is metered via brush rolls and is transported in front of the vehicle wheels. Sand scattering devices using brush rolls are also obtained from FR 1 456 746 A and US 2011/0297763 A1.

The static friction between vehicle wheel and ground is in particular increased particularly by using grit. However, in the known scattering devices the use of grit frequently results in a blocking of the metering or conveying roll which is why particularly powerful electric motors are used as the drive and the components of the scattering device are designed to be particularly robust. This increases both the weight and also the costs and usually also the installation size of the corresponding device.

The object of the present invention consists in providing an aforesaid device for scattering grit in front of the wheels of a vehicle which reduces the probability of a jamming of the brush roll by the grit used and at the same time does not require high drive powers for the drive. Disadvantages of the known scattering devices should be avoided or at least reduced.

The object according to the invention is solved whereby in the region of the feed inlet for the grit at least one wedge is arranged in front of the brush roll and tangentially and displaceably with respect to the brush roll so that the size of the feed inlet can be adjusted. The at least one displaceable wedge is used, on the one hand, to meter the desired or suitable quantity of grit. On the other hand, as a result of the at least one wedge, a wedging by the grit which is transported from the brush roll to the outlet is prevented since excess grit or also excessive sizes of grit (contaminated scattering material) is deflected or peeled off by the wedge. Thus, any jamming of the brush roll in the housing surrounding it by excess grit or oversize grit can be effectively avoided. By avoiding or reducing the probability of jamming of the brush roll, the drive of the brush roll can be designed to be smaller and weaker. Also the components such as the housing surrounding the brush roll can be used with smaller material thickness since the wear of the components is less. The present invention is characterized by a particularly simple and cost-effective design.

Preferably in the region of the feed inlet for the grit two wedges are arranged tangentially and displaceably with respect to the brush roll. As a result of such a symmetrical arrangement of two wedges, the feed inlet for the grit can be narrowed or opened from both sides and thus the desired amount of grit can be adjusted and metered particularly efficiently. Furthermore, such a symmetrical arrangement is suitable for both directions of rotation of the brush roll.

An intermediate space which is preferably 4-6 mm is arranged between the front faces of the brush roll and the cylindrical recess. The intermediate space between the front faces of the brush roll and the cylindrical recess in the housing must be adapted to the size of the grit used and reduces any jamming between brush roll and housing by the conveyed grit. The mentioned dimension of the gap between 4 and 6 mm is particularly suitable for usual grit having a diameter of about 6 mm.

According to a further feature of the invention, the brush roll has brushes arranged in sector form or a bundle of brushes with grooves arranged in between for receiving the grit. The number of grooves and the width thereof is adapted accordingly to the size and desired quantity of grit to be transported. For example, six to twelve grooves can be distributed between corresponding brush bundles over the circumference of the brush roll.

The brushes of the brush roll ideally consist of plastic and metal, in particular of polyamide and stainless steel. Such a combination of plastic and metal has a sufficient elasticity and at the same time corresponding resistance. In this case, brushes made of 50% polyamide, in particular Perlon, and 50% stainless steel having a wire thickness between 0.5 and 0.8 mm are particularly suitable.

The at least one wedge is preferably made of high-strength steel. By using this material too rapid wear of the at least one wedge is prevented. The housing of the device for scattering grit on the other hand can be made of a softer metal, for example, aluminium or also plastic, in particular polyoxymethylene (POM; in any case with glass fibre reinforcement) or silicon-magnesium compounds.

If the outlet for the grit has a cross-section which becomes larger towards the outside, an improved scattering effect can be achieved. As a result of an outwards opening outlet opening, the so-called throwing effect of the brush roll can be utilized, with the result that the grit is distributed over a larger area in front of the respective vehicle wheels.

The housing of the scattering device can be arranged in a container for the grit. As a result of such a design which differs from a flange mounting or fastening of the scattering device below the grit container, the overall size of the device can be reduced and a more compact design can be achieved.

The brush roll is connected to a drive, preferably to an electric motor. As already mentioned, as a result of the use according to the invention of at least one wedge, the risk of a jamming can be reduced which is why the electric motor can be used with lower drive power and therefore in smaller installation size.

A transmission can be arranged between drive and brush roll. As a result of such an arrangement, a plurality of brush rolls of several devices for scattering grit can be driven by only one drive.

In addition, a corresponding gear reduction can be achieved by the transmission.

The present invention will be explained in detail with reference to the appended drawings. In the drawings:

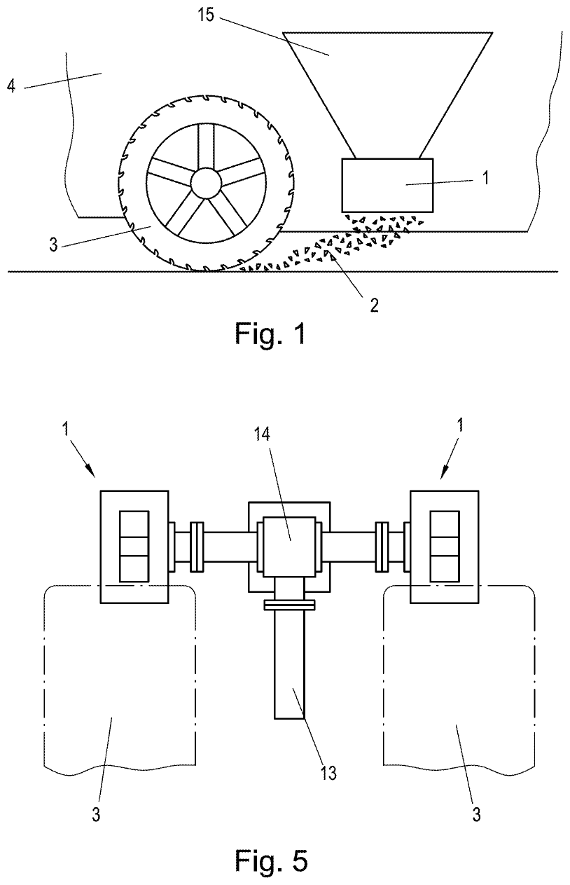

FIG. 1 shows a schematic diagram of a device for scattering grit mounted on a vehicle in front of the wheels of the wheel of the vehicle;

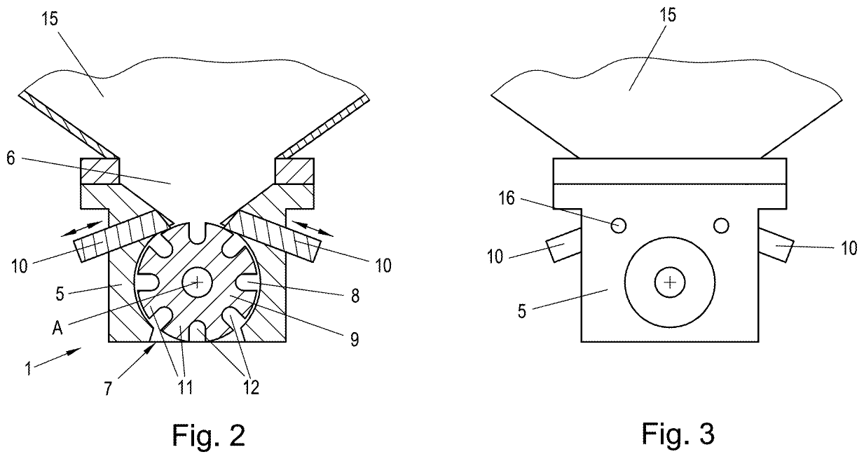

FIG. 2 shows a sectional drawing through an embodiment of a device according to the invention for scattering grit;

FIG. 3 shows a side view of the device for scattering grit according to FIG. 2 in closed form;

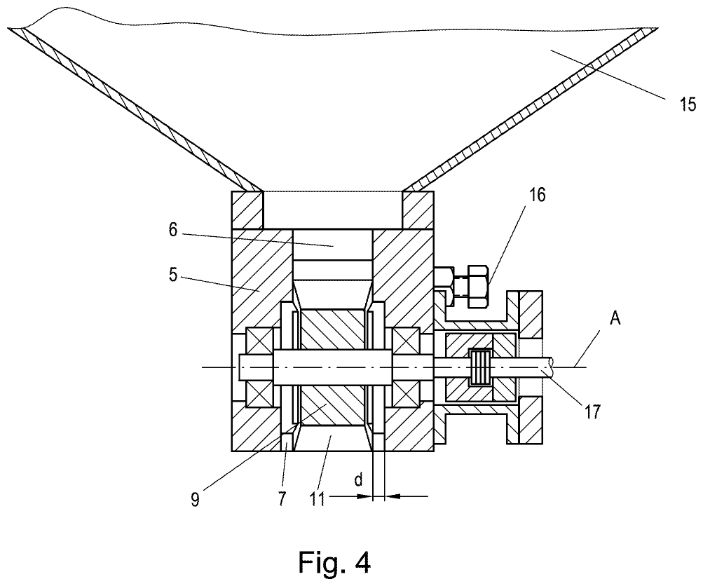

FIG. 4 shows a cutaway view of the device for scattering grit according to FIG. 2 from the side; and

FIG. 5 shows a diagram of two devices for scattering grit which are driven via a common drive and a transmission.

FIG. 1 shows a schematic diagram of a device 1 for scattering grit 2 in front of the wheels 3 of a vehicle 4. The device 1 is arranged at a suitable position of the vehicle 4 underneath a container 15 for the grit 2 so that the grit 2 can be dispensed to the desired place in front of the wheel 3 and can increase the static friction between wheel 3 and ground in order to facilitate starting up or shorten the braking distance.

FIG. 2 shows a sectional diagram through an embodiment of a device 1 according to the invention for scattering grit 2. The device 1 comprises a housing 5 with a feed inlet 6 for the grit 2 which coincides with a corresponding outlet of a container 15 for the grit 2. Ideally the walls of the container 15 are configured to be inclined in order to facilitate the trickling of the grit 2 stored therein due to gravity. A substantially cylindrical recess 8 is provided in the housing 5 in which a rotatably mounted and driven brush roll 9 is made possible for metering and conveying the grit 2 from the inlet 6 to an outlet 7. The brush roller 9 has a certain number of grooves 12 between brushes 11 or brush bundles. For the sake of simplicity the brushes 11 are not shown in detail here. The brushes 11 ideally consist of a combination of plastic and metal wires, for example, Perlon and stainless steel wires. According to the invention, in the region of the feed inlet 6 for the grit 2 at least one wedge 10 is arranged tangentially and displaceably with respect to the brush roll 9 so that the size of the feed inlet 6 can be adjusted. In addition, the front pointed side of the wedge 10 serves to scrape off or peel off excess grit 2 or oversize grit 2 with the result that the probability of a jamming of the brush roll 9 in the cylindrical recess 8 of the housing 5 can be reduced. Ideally, two wedges 10 arranged tangentially and displaceably with respect to the brush roll 9 are arranged on both sides of the feed inlet 6. The wedges 10 are preferably made of high-strength steel whereas the housing 5 can consist of plastic or light metal such as, for example, aluminium. The outlet 7 can, as indicated in FIG. 2, have a cross-section which becomes larger towards the outside so that the grit 2 can be dispensed over a larger area in front of the wheels 3 of the vehicle 4.

FIG. 3 shows a side view of the device 1 for scattering grit 2 according to FIG. 2 in closed form. In this view, clamping screws 16 can be identified for fastening the wedges 10 in the desired position. Usually the position of the wedges 10 is adapted accordingly to the desired position of the metered grit 2 and the size of the grit 2 used.

FIG. 4 shows a cutaway view of the device 1 for scattering grit 2 according to FIG. 2 from the side. Preferably an intermediate space d is arranged between the front face of the brush roll 9 and the housing 5, which intermediate space is ideally 4-6 mm when using grit 2 having an average diameter of about 6 mm. The brush roll 8 is connected to a corresponding drive 13 or transmission 14 via a corresponding drive shaft 17.

FIG. 5 shows a diagram of two devices 1 for scattering grit 2 which are driven via a common drive 13 and a transmission 14. In the exemplary embodiment shown, two devices 1 for scattering grit 2 are located in front of two vehicle wheels 3 and are connected to an electrical drive 13 via a common transmission 14.

The control of the rotational speed of the brush roll 9 and the duration of the activation of the brush roll 9 is usually accomplished manually by the driver of the vehicle 4. However, automatic activations of the device 1 for scattering grit 2 are also feasible if, for example, an anti-blocking device or an anti-slip system of the vehicle 4 detects a smooth ground. Usual rotational speeds for the brush roll 9 vary in the range between 30 and 35 rpm.

1-10. (canceled)

11. A device for scattering grit in front of wheels of a vehicle, the device comprising a housing having a feed inlet for the grit, an outlet for the grit and a substantially cylindrical recess for receiving a brush roll which is rotatably mounted and driven about a substantially horizontal axis of rotation for metered delivery of the grit from the feed inlet to the outlet, wherein in a region of the feed inlet for the grit two wedges are arranged in front of the brush roll and tangentially and displaceably with respect to the brush roll so that the feed inlet size is adjustable.

12. The device according to claim 11, wherein an intermediate space is arranged between the front faces of the brush roll and the cylindrical recess.

13. The device according to claim 11, wherein the brush rolls have brushes arranged in sector form with grooves arranged in between for receiving the grit.

14. The device according to claim 13, wherein the brushes of the brush roll are made of plastic and metal.

15. The device according to claim 11, wherein the wedges are made of high-strength steel.

16. The device according to claim 11, wherein the outlet for the grit has a cross-section which becomes larger.

17. The device according to claim 11, wherein the housing is arranged in a container for the grit.

18. The device according to claim 11, wherein the brush roll is connected to a drive.

19. The device according to claim 18, wherein a transmission is arranged between the drive and the brush roll.

20. The device according to claim 14, wherein the brushes of the brush roll are made of a polyamide and stainless steel.

21. The device according to claim 20, wherein the polyamide is Perlon.
